(19) United States
(12) Patent Application Publication
(10) Pub. No.: US 2015/0035362 A1
(43) Pub. Date: Feb. 5, 2015

(54) DETECTION CIRCUIT AND ELECTRONIC DEVICE USING SAME

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: YA-GUO WANG, Shenzhen (CN); CHUN-CHING CHEN, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/195,924

(22) Filed: Mar. 4, 2014

(30) Foreign Application Priority Data
Aug. 3, 2013 (CN) 201310073956X

(51) Int. Cl. H02J 1/00

(52) U.S. Cl. CPC H02J 1/00
USPC 307/31

(57) ABSTRACT

An electronic device includes a power supply, a processor, a storage, and a detection circuit. The power supply provides driving voltage to the processor and the storage. The processor is capable of generating different instructions for processing the data stored in the storage. The detection circuit connected to the power supply and the processor detects whether the driving voltage is less than a reference voltage. When the driving voltage is less than the reference voltage, the detection circuit generates a control signal for controlling the processor to be disabled.

### 1. TECHNICAL FIELD

The present disclosure relates to a detection circuit and an electronic device with the detection circuit.

### 2. DESCRIPTION OF RELATED ART

Electronic devices with a flash memory include a power supply and a processor. The flash memory is used for storing data. The power supply provides driving voltage to drive the processor and the flash memory. The processor generates different instructions for reading or erasing data of the flash memory. However, when the driving voltage for driving the flash memory is less than a predetermined voltage, the flash memory may recognize the instruction for reading data of the flash memory as an erase instruction and erase the data stored in the flash memory.

Therefore, there is room for improvement in the art.

### BRIEF DESCRIPTION OF THE FIGURE

The components of the drawings are not necessarily drawn to scale, the emphasis instead being placed upon clearly illustrating the principles of the embodiment of an electronic device. Moreover, in the drawings, like reference numerals designate corresponding parts throughout several views.

The FIGURE is a circuit diagram of an embodiment of an electronic device.

### DETAILED DESCRIPTION

The disclosure is illustrated by way of example and not by way of limitation in the FIGURE of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.” Embodiments of the present disclosure will be described in detail with reference to the drawings.

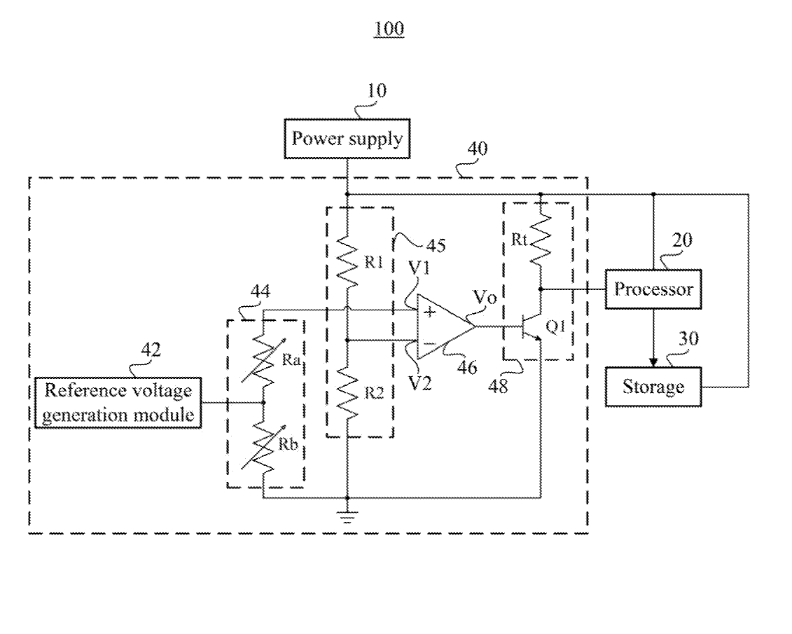

FIG. 1 shows an embodiment of an electronic device 100. The electronic device 100 includes a power supply 10, a processor 20, a storage 30, and a detection circuit 40. The electronic device 100 is capable of controlling the processor 20 to reset or be disabled when a voltage supplied by the power supply 10 is less than a reference voltage. In one embodiment, the reference voltage is less than 2.7 volts.

The power supply 10 provides a driving voltage to the processor 20, the storage 30, and the detection circuit 40. In one embodiment, the driving voltage can be one of a driving voltage range of 2.7-3.6 volts.

The processor 20 is electronically connected to the power supply 10, the storage 30, and the detection circuit 40. The processor 20 is capable of generating different instructions for controlling the storage 30. In one embodiment, the instructions are used for reading, storing, or erasing data of the storage 30, for example.

The storage 30 is used for storing data. The data in the storage 30 can be read or can be erased. In one embodiment, the storage is a flash memory.

The detection circuit 40 is electrically connected between the power supply 10 and the processor 20. The detection circuit 40 is used for detecting whether the driving voltage of the power supply 10 is less than the reference voltage. The detection circuit 40 includes a reference voltage generation unit 42, an adjustment unit 44, a sample unit 45, a comparator 46, and a switch unit 48.

The reference voltage generation unit 42 is used for providing the reference voltage to the adjustment unit 44.

The adjustment unit 44 is electrically connected between the reference voltage generation unit 42 and the comparator 46. The adjustment unit 44 is used for adjusting the reference voltage generated by the reference voltage generation unit 42.

The sample unit 45 is connected between the power supply 10 and the comparator 46. The sample unit 45 is used for sampling the driving voltage to obtain a sampled voltage.

The comparator 46 is electrically connected to the adjustment unit 45, the sample unit 44, and the switch unit 48. The comparator 46 includes a first input terminal V1, a second input terminal V2, and an output terminal Vo. The first input terminal V1 is connected to the adjustment unit 44. The second input terminal V2 is connected to the sample unit 45. The output terminal Vo is connected to the switch unit 48. When the sampled voltage is less than the reference voltage adjusted by the adjustment unit 44, the output terminal Vo generates a first signal. When the sampled voltage is more than or equal to the reference voltage adjusted by the adjustment unit 44, the output terminal Vo generates a second signal. In one embodiment, the first input terminal V1 is a non-inverting input terminal, and the second input terminal V2 is an inverting input terminal The first signal is a logic-high signal, and the second signal is a logic-low signal.

The switch unit 48 is electrically connected between the output terminal Vo of the comparator 46 and the processor 20. The switch unit 48 turns on for generating a control signal in response to the first signal, and turns off for stopping generating the control signal in response to the second signal. In one embodiment, the control signal is a logic-low signal.

The processor 20 is enabled and generates instructions in response to the driving voltage, and further is disabled in response to the control signal. In other embodiment, the processor 20 is reset in response to the control signal.

The adjustment unit 44 includes a first resistor Ra and a second resistor Rb. The first resistor Ra and the second resistor Rb are connected between the first input terminal V1 and a ground terminal in series. The reference voltage generation unit 42 is electronically connected between the first resistor Ra and the second resistor Rb. In one embodiment, the first resistor Ra and the second resistor Rb are variable resistors.

The sample unit 45 includes a first sample resistor R1 and a second sample resistor R2. The first sample resistor R1 and the second resistor R2 are connected between the power supply 10 and the ground terminal in series. The second input terminal V2 is connected between the first sample resistor R1 and the second resistor R2.

The switch unit 48 includes a transistor Q1 and a limiting resistor Rt. A base of the transistor Q1 is connected to the output terminal Vo. An emitter of the transistor Q1 is grounded. A collector of the transistor Q1 is connected to the power supply 10 through the limiting resistor Rt. The processor 20 is connected to the collector of the transistor Q1. In one embodiment, the transistor Q1 is an npn type bipolar junction transistor.

A working method of the electronic device 100 is described as follows. When the sampled voltage is less than the reference voltage adjusted by the adjustment unit 44, the output terminal Vo generates a first signal, the voltage difference between the base and the emitter of the transistor Q1 is more than 0.7 volts, which causes the transistor Q1 to turn on. The processor 20 receives the first control signal and is disabled.

When the sampled voltage is more than or equal to the reference voltage adjusted by the adjustment unit 44, the output terminal Vo generates a second signal, the voltage difference between the base and the emitter of the transistor Q1 is less than 0.7 volts, which cause the transistor Q1 to turn off. The processor 20 receives the driving voltage and is enabled.

In use, when the driving voltage of the power supply 10 is less than the reference voltage, the processor 20 is disabled and stops generating instructions to control the storage 30. Therefore, the stability of the storage 30 is improved.

While various exemplary and preferred embodiments have been described, the disclosure is not limited thereto. On the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. An electronic device, comprising:
a power supply providing a driving voltage;
a processor connected to the power supply and powered by the driving voltage;
a storage connected to the power supply and powered by the driving voltage; and
a detection circuit detecting whether the driving voltage for powering the storage is less than a reference voltage;
wherein the processor is capable of generating different instructions for processing data stored in the storage; when the driving voltage for powering the storage is less than the reference voltage, the detection circuit generates a control signal for controlling the processor to be disabled.

2. The electronic device of claim 1, wherein when the driving voltage is more than or equal to the reference voltage, the detection circuit stops generating the control signal, and the processor is enabled based on the driving voltage.

3. The electronic device of claim 1, wherein the detection circuit comprises a reference voltage generation unit, a sample unit, a comparator, and a switch unit; the comparator is connected to the sample unit, the reference generation unit, and the switch unit; the switch unit is connected between the comparator and the processor; the reference voltage generation unit provides the reference voltage to the comparator; the sample unit samples the driving voltage for providing to the comparator, the comparator compares the sampled voltage from the sample unit and the reference voltage from the reference voltage generation unit; when the sampled voltage is less than the reference voltage, the comparator outputs the first signal, the switch unit turns on for generating a control signal in response to the first signal, and the processor is disabled in response to the control signal.

4. The electronic device of claim 3, wherein the comprises a first input terminal, a second input terminal, and an output terminal; the first input terminal is connected to the voltage reference generation unit, and the second input terminal is connected to the sample unit; the first input terminal is a non-inverting input terminal, and the second input terminal is an inverting input terminal.

5. The electronic device of claim 3, wherein when the sampled voltage is more than or equal to the reference voltage, the comparator generates a second signal, the switch unit turns off for stopping generating the control signal in response to the second signal, the processor is enabled based on the driving voltage.

6. The electronic device of claim 3, wherein the sample unit comprises a first sampled resistor and a second sampled resistor; the first sampled resistor and the second sampled resistor are connected between the second output terminal and a ground terminal in series; the second input terminal is connected between the first resistor and the second resistor.

7. The electronic device of claim 3, wherein the switch unit comprises a transistor; a base of the transistor is connected to the comparator; an emitter of the transistor is grounded; a collector of the transistor is connected to the power supply; the processor is connected to the collector of the transistor.

8. The electronic device of claim 3, wherein the detection circuit further comprises an adjustment unit; the adjustment unit is connected between the reference voltage generation unit and the first input terminal; the adjustment unit is used for adjusting the reference voltage.

9. The electronic device of claim 8, wherein the adjustment unit comprises a first resistor and a second resistor; the first resistor and the second resistor are connected between the first output terminal and a ground terminal in series; the reference voltage generation unit is connected between the first resistor and the second resistor.

10. The electronic device of claim 9, wherein the first resistor and the second resistor are variable resistor.

11. An electronic device, comprising:
a power supply providing a driving voltage;
a storage connected to the power supply and powered by the driving voltage;
a processor connected to the storage and generating different instructions for processing data stored in the storage; and
a detection circuit connected to the power supply for detecting whether the driving voltage for powering the storage is less than a reference voltage;
wherein when the driving voltage for powering the storage is less than the reference voltage, the detection circuit generates a control signal for controlling the processor to stop generating the instructions for processing data stored in the storage.

12. The electronic device of claim 11, wherein the processor is also connected to the power supply and powered by the driving voltage.

13. The electronic device of claim 11, wherein when the driving voltage is more than or equal to the reference voltage, the detection circuit stops generating the control signal, and the processor is enabled based on the driving voltage.

14. The electronic device of claim 11, wherein the detection circuit comprises a reference voltage generation unit, a sample unit, a comparator, and a switch unit; the comparator is connected to the sample unit, the reference generation unit, and the switch unit; the switch unit is connected between the comparator and the processor; the reference voltage generation unit provides the reference voltage to the comparator; the sample unit samples the driving voltage for providing to the comparator, the comparator compares the sampled voltage from the sample unit and the reference voltage from the reference voltage generation unit; when the sampled voltage is less than the reference voltage, the comparator outputs the first signal, the switch unit turns on for generating the control signal in response to the first signal, and the processor is disabled in response to the control signal.

15. The electronic device of claim 14, wherein when the sampled voltage is more than or equal to the reference voltage, the comparator generates a second signal, the switch unit turns off for stoppings generating the control signal in response to the second signal, the processor is enabled based on the driving voltage.

16. The electronic device of claim 14, wherein the sample unit comprises a first sampled resistor and a second sampled resistor; the first sampled resistor and the second sampled resistor are connected between the second output terminal and a ground terminal in series; the second input terminal is connected between the first resistor and the second resistor.

17. The electronic device of claim 14, wherein the switch unit comprises a transistor; a base of the transistor is connected to the comparator; an emitter of the transistor is grounded; a collector of the transistor is connected to the power supply; the processor is connected to the collector of the transistor.

18. The electronic device of claim 14, wherein the detection circuit further comprises an adjustment unit; the adjustment unit is connected between the reference voltage generation unit and the first input terminal; the adjustment unit is used for adjusting the reference voltage.

19. The electronic device of claim 18, wherein the adjustment unit comprises a first resistor and a second resistor; the first resistor and the second resistor are connected between the first output terminal and a ground terminal in series; the reference voltage generation unit is connected between the first resistor and the second resistor.

20. The electronic device of claim 19, wherein the first resistor and the second resistor are variable resistor.
